(19) United States
(12) Patent Application Publication
(10) Pub. No.: US 2004/0219398 A1
(43) Pub. Date: Nov. 4, 2004

(54) Fuel cell control and data reporting

(76) Inventor: John C. Calhoon, Woodinville, WA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/620,756

(22) Filed: Jul. 16, 2003

Related U.S. Application Data
(60) Provisional application No. 60/467,393, filed on May 2, 2003.

(51) Int. Cl. H01M 8/00; H01M 8/04; H01M 8/12; H01M 8/10; H01M 2/00; H01M 2/02; H01M 10/48

(52) U.S. Cl. 429/13; 429/22; 429/23; 429/34; 429/24; 429/30; 429/33

(57) ABSTRACT

A fuel cell pack having a fuel tank, a smart controller, and a fuel cell provides electrical power and operational data pertaining to the fuel cell pack to a host processor. The fuel cell pack and the host processor control the operation of the fuel cell. Control of the fuel cell includes starting and shutting down the fuel cell, and metering the amount of fuel provided to the fuel cell. Operational data is provided to the fuel cell via an I₂C bus formatted in compliance with industry standard specifications such as the Smart Battery Specification and the Advanced Configuration and Power Interface (ACPI) Specification.

### CROSS REFERENCE TO RELATED APPLICATIONS

This application claims benefit of Provisional Patent Application No. 60/467,393, filed May 2, 2003, under docket number MSFT-2159, entitled “FUEL CELL CONTROL AND DATA REPORTING”, and is hereby incorporated by reference in its entirety.

### FIELD OF THE INVENTION

The present invention is generally relates to fuel cells and more specifically relates to fuel cells that provide power to electronic devices.

### BACKGROUND OF THE INVENTION

Portable electronic devices such as mobile PCs, PDAs, wireless phones, portable media players, digital still cameras, and digital video cameras are typically powered by batteries and/or AC power. In many cases the battery, or battery pack, is rechargeable.

FIG. 1 is an illustration of an exemplary fuel cell. A fuel cell transforms chemical power into electrical power. In that respect, a fuel cell operates like a battery, however, unlike a battery, a fuel cell does not run down or require recharging. A fuel cell converts hydrogen, H₂, and oxygen, O₂, into water producing electricity and heat. A fuel cell can produce energy in the form of electricity and heat as long as fuel is supplied. A fuel cell comprises a pair of electrodes (cathode and anode) and an electrolyte. The electrolyte is typically positioned between the electrodes. The electrolyte functions as a conductor for carrying ions between the electrodes. An electrolyte is classified as a liquid electrolyte, a solid electrolyte, or a gaseous electrolyte, depending upon the physical state of the fuel utilized by the electrolyte. An electrolyte can comprise, for example, a solution of alkali, an acid, or molten carbonate. In operation, a fuel, such as hydrogen, H₂, is fed into the anode and oxygen, O₂, is fed into the cathode. The hydrogen atoms, reacting with a catalyst in the anode, split into protons and electrons, each of which takes a different path to the cathode. The protons pass through the electrolyte and the electrons are used to supply electrical power. Often, a fuel cell includes a fuel reformer that provides hydrogen from a fuel source, such as natural gas, methanol, gasoline, or the like.

A variety of fuel cell types are known in the art. Example types of fuel cells include phosphoric acid fuel cells (PAFCs), proton exchange membrane (PEM) fuel cells, molten carbonate fuel cells (MCFCs), solid oxide fuel cells (SOFCs), alkaline fuel cells, direct methanol fuel cells fuel cells (DMFCs), regenerative fuel cells, zinc-air fuel cells (ZAFCs), and protonic ceramic fuel cells (PCFCs). A brief summary of each of these types of fuel cells is provided below.

Phosphoric Acid Fuel Cell (PAFC): PAFCs can generate electricity at more than 40% efficiency. The PAFC utilizes a platinum electro-catalyst in its anode and the electrolyte is liquid phosphoric acid soaked in a matrix. At lower temperatures, phosphoric acid is a poor ionic conductor, and carbon monoxide poisoning of the platinum electro-catalyst becomes severe. Operating temperatures range from approximately 300 to 400 degrees F. (150-200 degrees C.). Thus, the PAFC produces steam as a byproduct. Approximately 85% of the steam generated by a PAFC can be used for cogeneration. Another advantage is that a PAFC can use impure hydrogen as fuel. PAFCs can tolerate a CO concentration of about 1.5%, which broadens the choice of acceptable fuels. Gasoline can be used as a fuel if the sulfur is removed. PAFCs generate relatively low current and power as compared to other types of fuel cells, and PAFCs are generally relatively large heavy. PAFCs can produce outputs up to 1 MW. The chemical equations describing reactions in the anode, cathode, and the fuel cell are provided below.

Anode: H2(g)->2H+(aq)+2e−

Cathode: 1/2O2(g)+2H+(aq)+2e−->H2O(l)

Cell: H2(g)+1/2O2(g)+CO2->H2O(l)+CO2

Proton Exchange Membrane (PEM): PEM fuel cells operate at relatively low temperatures (about 175 degrees F. or 80 degrees C.), have high power density, and can vary their output quickly to meet shifts in power demand. The PEM is a thin plastic sheet that allows hydrogen ions to pass through it. The membrane is coated on both sides with highly dispersed metal alloy particles (e.g., platinum) that are active catalysts. The electrolyte comprises a solid organic polymer, poly-perflourosulfonic acid. Hydrogen is fed to the anode side of the fuel cell where the catalyst encourages the hydrogen atoms to release electrons and become hydrogen ions (e.g., protons). The electrons travel in the form of an electric current that can be utilized before it returns to the cathode side of the fuel cell where oxygen has been fed. At the same time, the protons diffuse through the membrane (electrolyte) to the cathode, where the hydrogen atom is recombined and reacted with oxygen to produce water, thus completing the overall process. The PEM fuel cell is sensitive to fuel impurities. PEM fuel cell outputs generally range from approximately 50 to 250 kW. The chemical equations describing reactions in the anode, cathode, and the fuel cell are provided below.

Anode: H2(g)->2H+(aq)+2e−

Cathode: 1/2O2(g)+2H+(aq)+2e−->H20(l)

Cell: H2(g)+1/2O2(g)->H20(l)

Molten Carbonate Fuel Cell (MCFC): The electrolyte of a MCFC comprises a liquid solution of lithium, sodium and/or potassium carbonates, soaked in a matrix. MCFC can provide fuel-to-electricity efficiencies, of approximately 60% normally (without cogeneration) and approximately 85% with cogeneration. MCFC operate at about 1,200 degrees F. or 650 degrees C. The high operating temperature is needed to achieve sufficient conductivity of the electrolyte. Because of this high temperature, noble metal catalysts are not required for the MCFC's electrochemical oxidation and reduction processes. Fuels for MCFCs include hydrogen, carbon monoxide, natural gas, propane, landfill gas, marine diesel, and simulated coal gasification products. The chemical equations describing reactions in the anode, cathode, and the fuel cell are provided below.

Anode: H2(g)+CO32−->H2O(g)+CO2(g)+2e−

Cathode: 1/2O2(g)+CO2(g)+2e−->CO32−

Cell: H2(g)+2O2(g)+CO2(g)->H2O(g)+CO2(g)

Solid Oxide Fuel Cell (SOFC): A SOFC typically uses a hard ceramic material of solid zirconium oxide and a small amount of ytrria, instead of a liquid electrolyte, allowing operating temperatures to reach 1,800 degrees F. or 1000 degrees C. Power generating efficiencies can reach approximately 60% (without cogeneration) and 85% with cogeneration. Power output can be as high as approximately 100 kW. One type of SOFC comprises an array of meter-long tubes. Tubular SOFCs have produced as much as 220 kW. The chemical equations describing reactions in the anode, cathode, and the fuel cell are provided below.

Anode: H2(g)+O2−->H2O(g)+2e−

Cathode: 1/2O2(g)+2e−->O2−

Cell: H2(g)+2O2(g)->H2O(g)

Alkaline Fuel Cell: Alkaline fuel cells can achieve power generating efficiencies of up to approximately 70 percent. The operating temperature of an alkaline fuel cell is from approximately 300 to 400 degrees F. (about 150 to 200 degrees C.). Alkaline fuel cells use an aqueous solution of alkaline potassium hydroxide soaked in a matrix as the electrolyte. Alkaline fuel cells typically provide a cell output from approximately 300 watts to 5 kW. The chemical equations describing reactions in the anode, cathode, and the fuel cell are provided below.

Anode: H2(g)+2(OH)−(aq)->2H2O(l)+2e−

Cathode: 1/2O2(g)+H2O(l)+2e−->2(OH)−(aq)

Cell: H2(g)+1/2O2(g)->H2O(l)

Direct Methanol Fuel Cell (DMFC): DMFCs are similar to PEM cells in that they both use a polymer membrane as the electrolyte. However, in the DMFC, the anode catalyst itself draws the hydrogen from the liquid methanol, eliminating the need for a fuel reformer. Efficiencies of about 40% are expected with a DMFC. The DMFC can typically operate at a temperature between approximately 120-190 degrees F. or 50-100 degrees C. Higher efficiencies are achieved at higher temperatures. The chemical equations describing reactions in the anode, cathode, and the fuel cell are provided below.

Anode: CH3OH(aq)+H2O(l)->CO2(g)+6H+(aq)+6e−

Cathode: 6H+(aq)+6e−+3/2O2(g)->3H2O(l)

Cell: CH3OH(aq)+3/2O2(g)->CO2(g)+2H2O(l)

Regenerative Fuel Cells: Regenerative fuel cells are attractive as a closed-loop form of power generation. Water is separated into hydrogen and oxygen by a solar-powered electrolyser. The hydrogen and oxygen are fed into the fuel cell which generates electricity, heat and water. The water is then re-circulated back to the solar-powered electrolyser and the process begins again.

Zinc-Air Fuel Cells (ZAFC): In a typical zinc-air fuel cell, there is a gas diffusion electrode (GDE), a zinc anode separated by electrolyte, and some form of mechanical separators. The GDE is a permeable membrane that allows atmospheric oxygen to pass through. After the oxygen has converted into hydroxyl ions and water, the hydroxyl ions travel through an electrolyte, and reach the zinc anode. At the zinc anode, the hydroxyl ions react with the zinc, and form zinc oxide. This process creates an electrical potential. When a set of ZAFC cells are connected, or stacked, the combined electrical potential of these cells can be used as a source of electric power. ZAFCs can be used in a closed-loop system. In this closed-loop system, electricity is created as zinc and oxygen are mixed in the presence of an electrolyte, creating zinc oxide. Once fuel is consumed, the system is connected to the grid and the process is reversed, leaving once again pure zinc fuel pellets. This reversing process takes only about 5 minutes to complete. An advantage possessed by zinc-air technology over other battery technologies is its high specific energy, which is a factor used to determine the running duration of a battery relative to its weight.

Protonic Ceramic Fuel Cell (PCFC): The PCFC comprises a ceramic electrolyte material that exhibits high protonic conductivity at elevated temperatures. PCFCs share the thermal and kinetic advantages of high temperature operation at approximately 700 degrees C. with molten carbonate and solid oxide fuel cells, while exhibiting all of the intrinsic benefits of proton conduction in polymer electrolyte and PAFCs. The high operating temperature helps to achieve very high electrical fuel efficiency with hydrocarbon fuels. PCFCs can operate at high temperatures and electrochemically oxidize fossil fuels directly to the anode. This eliminates the intermediate step of producing hydrogen through the reforming process. Gaseous molecules of the hydrocarbon fuel are absorbed on the surface of the anode in the presence of water vapor, and hydrogen atoms are efficiently stripped off to be absorbed into the electrolyte, with carbon dioxide as the primary reaction product. Additionally, PCFCs have a solid electrolyte so the membrane does not dry out as with PEM fuel cells, or liquid can't leak out as with PAFCs.

It is expected that the fuel cell will compete with many types of energy conversion devices, including the gas turbine in a power plant, the gasoline engine in a car, and the battery in a laptop. A fuel cell provides a DC (direct current) voltage that can be used to power motors, lights or any number of electrical appliances.

As fuel cells emerge as a power source for these devices, there is a desire to have one or more standard control and data interface mechanisms, reducing the costs and time required to introduce fuel cells into the portable electronic ecosystem.

### SUMMARY OF THE INVENTION

A fuel cell pack in accordance with an embodiment of the present invention comprises a fuel tank, a smart controller, and a fuel cell. The fuel cell pack provides electrical power and operational data pertaining to the fuel cell pack to a host processor. The fuel cell can operate on liquid, gaseous, or solid fuel. The host processor can be any appropriate type of portable or stationary electronic device, such as a mobile PC, a desktop PC, a personal digital assistant (PDAs), a portable phone, a radio, a television, test equipment, and Smart Personal Objects, for example. The fuel cell pack and the host processor control the operation of the fuel cell. The fuel pack housing is desirably interchangeable.

Control of the fuel cell includes starting and shutting down the fuel cell, and metering the amount of fuel provided to the fuel cell. In one embodiment, operational data is provided from the fuel cell via an I₂C bus formatted in compliance with industry standard specifications such as the Smart Battery Specification and the Advanced Configuration and Power Interface (ACPI) Specification.

A system for providing data from a fuel cell to a computer operating system in accordance with the present invention includes a fuel tank, the fuel cell, a smart controller, and a host processor. The fuel cell is coupled to the fuel tank. The fuel cell receives fuel from within the fuel tank. The system also includes sensors for sensing fuel cell characteristics and for providing sensor signals indicative of the fuel cell characteristic to the smart controller. The smart controller is coupled to the fuel tank and to the fuel cell. The smart controller determines fuel cell parameter values in accordance with the sensed fuel cell characteristics. The host processor includes the operating system and a fuel indicator. The system also includes a data bus for providing the data from the fuel cell to the host processor. The data includes at least one of the determined fuel cell parameters. The smart controller is coupled to the host processor via the data bus. A method for providing data from the fuel cell pack to the computer operating system using this system includes determining the remaining amount of fuel in the fuel cell pack. The remaining amount of fuel cell power is determined in accordance with the remaining amount of fuel. The electrical consumption rate being consumed by the computer operating system is measured, and values indicative of the remaining amount of power and the electrical consumption rate are transmitted from the fuel cell pack to the computer operating system.

### BRIEF DESCRIPTION OF THE DRAWINGS

The features and advantages of the present invention will be best understood when considering the following description in conjunction with the accompanying drawings, of which:

FIG. 1 is an illustration of an exemplary fuel cell (prior art);

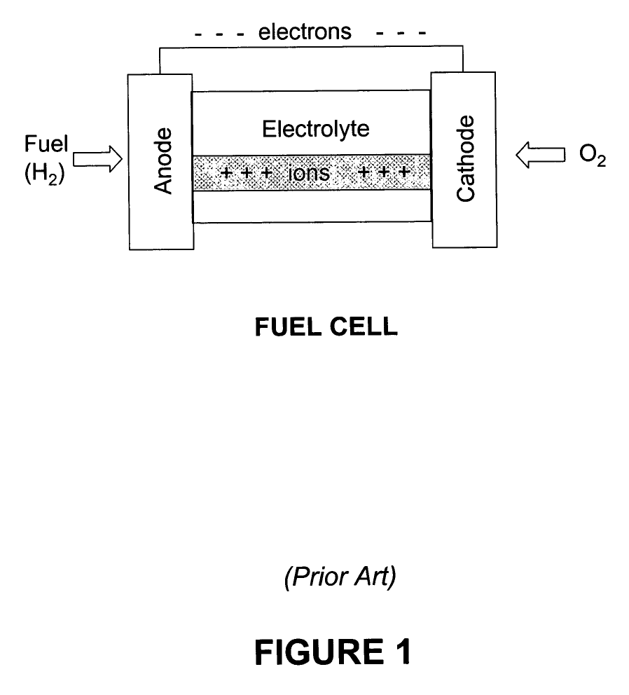

FIG. 2 is an illustration of a system for controlling, and reporting data pertaining to, a fuel cell utilizing a liquid fuel, in accordance with an exemplary embodiment of the present invention;

FIG. 3 is an illustration of a system for controlling, and reporting data pertaining to, a fuel cell utilizing a gaseous fuel, in accordance with an exemplary embodiment of the present invention; and

FIG. 4 is a flow diagram of a process for providing data from a fuel cell pack to a host processor in accordance with an exemplary embodiment of the present invention.

### DETAILED DESCRIPTION OF ILLUSTRATIVE EMBODIMENTS

Fuel cell control and data reporting in accordance with the present invention provides for controlling a fuel cell power source in an electronic device and for reporting information about the fuel cell to its host system. As described above, fuel cell control and data reporting is applicable to any appropriate type of portable or stationary electronic device, such as mobile PCs, desktop PCs, personal digital assistants (PDAs), portable phones, radios, televisions, test equipment, and Smart Personal Objects, for example. Also, various types of fuel cells can be utilized. Described herein are exemplary embodiments utilizing a liquid fuel cell and a gaseous fuel cell. It is to be understood, however, that other types of fuel cells are also applicable.

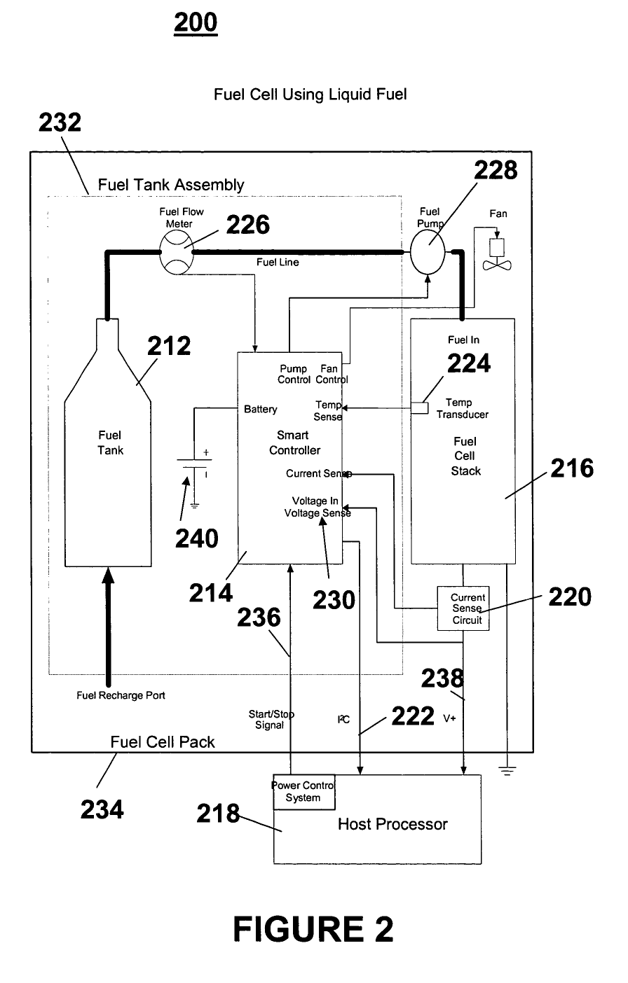

FIG. 2 is an illustration of an exemplary system 200 for controlling, and reporting data pertaining to, a fuel cell utilizing a liquid fuel. The system 200 comprises a fuel cell pack 234 and a host processor 218. The fuel cell pack 234 comprises a fuel tank 212, a fuel cell 216, and a smart controller 214. The fuel tank 212 is a container for the fuel provided to the fuel cell 216. The fuel tank 212 can be refillable, rechargeable, replaceable, or a combination thereof. Any appropriate liquid fuel can be used, such as the fuels described above for example. The fuel cell 216 can comprise a single cell or a plurality of cells (e.g., stacked). The fuel cell pack 234 comprises a fuel flow meter 226 and a fuel pump 228 for controlling the flow of fuel from the fuel tank 212 to the fuel cell 216. The smart controller 214 controls the flow of fuel from the fuel tank 212 to the fuel cell 216, and provides information associated with the fuel cell pack 234 to an operating system hosted by the host processor 218. The smart controller 214 is also capable of performing mathematical calculations, storing and retrieving data from memory within the smart controller 214, and performing input/output (I/O) functions.

The components of the system 200 can be assembled in a variety of configurations. In one embodiment, the system 200 comprises a fuel tank assembly 232 that includes the fuel tank 212 that is appropriate for the fuel, a flow sensor 226, the smart controller 214, and a battery 240. In this embodiment, the fuel tank assembly 232 connects to the fuel cell 216 via tubing or the like for transporting the fuel from the fuel tank 212 to the fuel cell 216. Also, the fuel tank assembly 232 can be replaceable. Thus, a coupling mechanism can be provided for facilitating replacement of the fuel tank assembly 232.

A coupling mechanism is not depicted in FIG. 2, however any appropriate mechanism for detachably coupling the fuel tank assembly 232 to the fuel cell pack 234 can be used. For example, the fuel tank assembly 232 can be inserted and withdrawn via a snap fit connector, or the fuel tank assembly 232 can be attached and detached from the fuel cell pack 234 via a threaded connector. The fuel tank assembly 232 also includes electrical connections to the fuel cell 216 and to the host processor 218 power control circuitry via control signal interface 236.

In another embodiment, the fuel cell pack 234 is replaceable. In each of these embodiments, the components of the fuel cell pack 234 are desirably enclosed in a housing similar to that used for current battery packs and that the fuel tank assembly 234 is refillable and replaceable by a user. Thus, the fuel cell pack is desirably interchangeable with and functionally compatible with a battery pack. For example, if the host processor 218 is a laptop computer capable of receiving electrical power from a battery pack, the fuel cell pack 234 is interchangeable with that battery pack and provides at least the same power and information to the laptop's operating system as the battery pack.

The fuel cell pack 234 also comprises a current sense circuit 220. The current sense circuit 220 senses the electrical current being provided to the host processor 218 from the fuel cell pack 234 and provides a signal indicative of this sensed electrical current to the smart controller 214. Also, a signal indicative of the voltage provided to the host processor 218 from the fuel cell pack 234 is provided to the smart controller 214 at voltage sense point 230.

In another embodiment, the fuel cell pack 234 comprises a fuel reformer (not shown in FIG. 2) for converting the fuel contained in the fuel tank 212 to a fuel that is usable by the fuel cell 216. The fuel reformer can be integral to the fuel cell 216, separate from the fuel cell 216, or a combination thereof.

As depicted in FIG. 2, the system 200 can also comprise a fan or other mechanical device for inducing airflow through the fuel cell 216. The fan can be integral to the fuel cell 216, separate from the fuel cell 216, or a combination thereof. The battery 240 can be internal to the fuel cell pack 234 or can be located in the host processor 218.

The smart controller 214 is electrically coupled to the fuel flow meter 226, the fuel pump 228, the fuel cell temperature sensor 224, and the current sense circuit 220. The smart controller 214 also comprises the voltage sensor 230, which receives a signal indicative of the voltage of the power signal provided to the host processor 218. As described in more detail below, the smart controller 214 receives signals indicative of the sensed fuel cell temperature, the sensed electrical current provided to the host processor 218, and fuel flowing through the fuel flow meter 226, and utilizes these parameters to control the amount of fuel provided to the fuel cell 218 via the fuel pump 228, and provides data pertaining to the fuel cell to the host processor 218. The smart controller 214 provides information pertaining to the fuel cell pack 234 via the data signal interface 222.

In an exemplary embodiment, the data signal interface 222 is a data bus interface compatible with the inter-IC (I²C) bus specification for communication with the host processor 218. The I²C bus specification is known in the art and described in a document titled “THE I²C BUS SPECIFICATION”, Version 2.1, dated January 2000, which is hereby incorporated by reference as if presented herein. The smart controller 214 also receives start and stop commands from the host processor 218 via the control signal interface 236. In the case where a fan or other mechanical mechanism is used to induce airflow through the fuel cell 216, the smart controller 214 preferably will control this device as well.

In accordance with the present invention, the host processor 218 controls the operation of the fuel cell pack 234 via the control signal interface 236 and the smart controller 214 provides operational data about the fuel cell pack 234 to the host processor 218 via data interface 222. The fuel cell pack provides power to the host processor via power signal interface 238. The operating system of the host processor 218 utilizes the received operational data to control the fuel cell pack 234 and to provide an indication of the status of the fuel cell pack 234. Control can comprise, for example, starting up and shutting down the fuel cell pack 234, and metering the amount of fuel supplied to the fuel cell via fuel pump 228. Example operational data is provided below.

Power Unit: The power unit indicates whether power parameters are expressed as milli-amperes (mA) or milli-watts (mW).

Design Capacity: The design capacity indicates the nominal maximum amount of power the fuel cell pack can provide in Power Units.

Last Full Charge Capacity: The last full charge capacity indicates the amount of power the fuel cell pack can provide in Power Units, based on its last refueling. In one embodiment, the Design Capacity and Last Full Charge Capacity are equal.

Design Voltage: The design voltage indicates the nominal voltage supplied by the fuel cell pack.

Design Capacity of Warning: The design capacity of warning indicates a power level in Power Units at which the host processor 218 should warn the user that power is running low.

Design Capacity of Low: The design capacity of low indicates a power level in Power Units to the host processor 218 that the remaining power available from the fuel cell pack 234 is critically low.

Capacity Granularity 1: The capacity granularity 1 indicates the difference between the Design Capacity of Low and the Design Capacity of Warning in Power Units.

Capacity Granularity 2: The capacity granularity 2 indicates the difference between Last Full Charge and Design Capacity of Warning in Power Units.

Model Number: The model number is a character string selected by the manufacturer.

Serial Number: The serial number is a unique number assigned by the manufacturer.

OEM Information: The OEM information is a character string supplied by the manufacturer for providing additional information about the fuel cell stack.

State: The state indicates whether the fuel cell pack is providing power.

Present Rate: The present rate indicates how much power is being provided to the host system in Power Units.

Remaining Capacity (C_{R}): C_{R} indicates the fuel cell's remaining capacity in Power Units.

Present Voltage: The present voltage indicates the voltage across the fuel cell pack's supply terminals.

Volume Unit: The volume unit indicates how the fuel volumes are reported. This unit will typically be ml for liquid fuels and moles for gaseous fuels.

Full Volume (F_{T}): F_{T} indicates the fuel volume when the fuel tank is full, in other words, the volume of the fuel tank.

Volume Consumed (F_{C}): F_{C} indicates the amount of fuel consumed since the fuel tank was last refueled.

Remaining Volume (F_{R}): F_{R} indicates the current volume of fuel in the fuel tank.

In one embodiment, parameters are pre-stored in the smart controller's 214 memory prior to using the fuel cell pack 234. The smart controller's 214 memory can include any appropriate storage mechanism such as permanently programmed registers, read only memory (ROM), locations in random access memory (RAM) (preferably non-volatile), disk storage, or a combination thereof, for example. Examples of pre-stored parameters are provided below in Table 1.

TABLE 1
Exemplary Pre-Stored Parameters

| | |
|---|---|
| Power Unit | Described Above |
| Design Capacity | Described Above |
| Design Voltage | Described Above |
| Design Capacity of Warning | Described Above |
| Design Capacity of Low | Described Above |
| Capacity Granularity 1 | Described Above |
| Capacity Granularity 2 | Described Above |
| Model Number | Described Above |
| Serial Number | Described Above |
| OEM Information | Described Above |
| F_{T} | Described Above |
| K_{E} | See Below |
| Volume Unit | See Below |

K_{E} is an energy conversion constant for the fuel cell stack expressed in mill-watt hours (mWh) or milli-ampere hours (mAh) per fuel volume. This constant is preferably determined by testing the energy output of the fuel cell stack with a given amount of fuel and is indicative of the energy density of the fuel and the conversion efficiency of the fuel stack. The volume unit indicates how fuel volume is reported. This unit will typically be in milli-liters (ml) for liquid fuels

In operation, during a quiescent state, the fuel cell pack 234 is not generating power and is not consuming fuel. The smart controller 214 is in an idle state consuming minimal battery power from the battery 240 while awaiting a start signal from the host processor 218 via control signal interface 236. Once the host processor 218 asserts a start signal via the control signal interface 236, the smart controller 214 starts the fuel pump 228 and fan (if utilized). The smart controller 214 also begins to monitor fuel consumption of fuel from the fuel tank 212, voltage output provided to the host processor 218 from the fuel cell pack 234 via power signal interface 238, the electrical current being drawn from the fuel cell pack 234 by the host processor 218 via the power signal interface 238, and the temperature of the fuel cell 224 via the temperature sensor 224.

In one embodiment, when the fuel cell pack 234 is providing its rated voltage to the host processor 218, the smart controller 214 uses power generated by the fuel cell 216 instead of from the battery 240. Additionally, the electrical current supplied by the fuel cell 216 can be used to charge the battery in the host processor 218 and the fuel cell pack battery 240 (if separate from the host processor's 218 battery), rather than supplying power to the host processor 218 only.

The smart controller 214 continuously meters fuel from the fuel tank 212 to the fuel cell 216 by controlling the fuel pump 228 using an algorithm appropriate to the fuel cell 216 design. Additionally, the smart controller 214 continuously monitors the temperature of the fuel cell 216 via the temperature sensor 224, and if the temperature exceeds a pre-determined point the smart controller 214 can turn the fuel pump 228 off to prevent failure of, or damage to, the fuel cell 216 and/or the host processor 218.

The voltage output of the fuel cell 216 and the current drawn from the fuel cell 216 are continuously monitored by the smart controller 214 and made available for reporting to the host processor 218. The voltage and current sensor interfaces in the smart controller 214 can comprise any appropriate device, circuitry, and/or software, such as an integrated analog-to-digital converter, for example. Similarly, the temperature interface in the smart controller 214 can comprise any appropriate device, circuitry, and/or software, such as an integrated analog-to-digital converter, for example.

During operation the smart controller 214 calculates the volume of fuel consumed (F_{C}) (e.g., on a periodic basis) utilizing the output of the fuel flow meter 226. The smart controller 214 stores this value (F_{C}) in memory in the smart controller 214. Preferably this memory comprises non-volatile storage to maintain the value of F_{C} when the fuel cell pack 234 is turned on and off. In one embodiment, fuel consumed, F_{C}, is a re-settable counter and is set to zero each time the fuel tank 212 is re-fueled. Fuel Remaining (F_{R}) is also calculated on a periodic basis and can be stored in a register or memory location in the smart controller 214. Note, it is not required that the value of F_{R} be stored in a non-volatile location. In one embodiment, the fuel remaining F_{R} is calculated in accordance with the following equation (1).

F_{R}=F_{T}−F_{C}, where (1)

F_{R} is the amount of fuel remaining, F_{T} is the total amount of fuel, and F_{C} is the amount of fuel consumed.

The smart controller 214 also desirably calculates the remaining power capacity (C_{R}) that the fuel cell pack 234 can deliver. In one embodiment, the value of C_{R} is stored in a register or memory location in the smart controller 214. Note the value of C_{R} is not required to be stored in a non-volatile location. In one embodiment, the remaining power capacity, C_{R}, is calculated in accordance with the following equation (2).

C_{R}=F_{R}*K_{E}, where (2)

C_{R} is the value of the remaining power capacity, F_{R} is amount of the remaining fuel, and K_{E} is an energy conversion constant for the fuel cell 216.

The smart controller 214 also desirably computes the average electrical current draw from the fuel cell 216 along with the predicted runtime of the system and the percentage of energy left in the fuel tank 212. In one embodiment, the predicted runtime is calculated in accordance with the following equation (3).

T_{R}=C_{R}/R_{A}, where (3)

T_{R} is the time remaining, C_{R} is the remaining capacity in the fuel cell 212, and R_{A=}average rate at which fuel is being consumed.

These data are provided to the host processor 218 by the fuel cell pack 234. As provided to the host processor 218, these data are compatible with the standards and specifications with which the host processor 218 is compatible. In one embodiment, the smart controller 214 communicates with the host processor 218 via I²C bus (or other communication bus) when queried. Data transferred between the smart controller 214 and the host processor 218 are formatted to be in compliance with industry standard specifications such as the Smart Battery Specification and the Advanced Configuration and Power Interface (ACPI) Specification, for example. The data can also be formatted to be compatible with proprietary structures as specified by the host processor 218 manufacturer. Data provided to the host processor 218 can be used for the purpose of performing power management throughout the system (e.g., fuel cell pack 234 and the host processor 218) and/or to present the user with information about the fuel cell pack 234.

Information pertaining to the fuel cell pack 234 can be presented to the user in the form of a visual display (e.g., fuel gauge, time remaining), in the form of an audio cue (e.g., time remaining is below a predetermined threshold value), a mechanical cue (e.g., hand held device vibrates when time remaining is below a predetermined threshold value), or a combination thereof, for example.

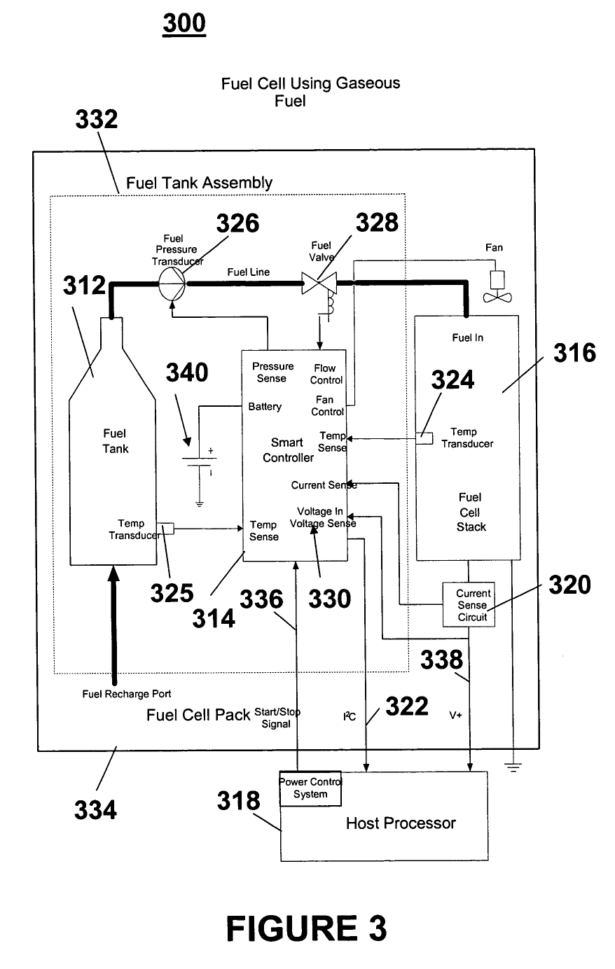

FIG. 3 is an illustration of an exemplary system 300 for controlling, and reporting data pertaining to, a fuel cell utilizing a gaseous fuel. The configuration and operation of the system 300 is similar to the system 200 except for differences to accommodate a gaseous fuel rather than a liquid fuel. The system 300 comprises a fuel cell pack 334 and a host processor 318. The fuel cell pack 334 comprises a fuel tank 312, a fuel cell 316, and a smart controller 314. The fuel tank 312 is a container for the fuel provided to the fuel cell 316. The fuel tank 312 can be refillable, rechargeable, replaceable, or a combination thereof. Any appropriate gaseous fuel can be used, such as the fuels described above for example. The fuel cell 316 can comprise a single cell or a plurality of cells (e.g., stacked). The fuel cell pack 334 comprises a fuel pressure transducer 326 and a fuel valve 328 for controlling the flow of fuel from the fuel tank 312 to the fuel cell 316. The smart controller 314 controls the flow of fuel from the fuel tank 312 to the fuel cell 316, and provides information associated with the fuel cell pack 334 to an operating system hosted by the host processor 318. The smart controller 314 is also capable of performing mathematical calculations, storing and retrieving data from memory within the smart controller 314, and performing input/output (I/O) functions.

The components of the system 300 can be assembled in a variety of configurations. In one embodiment, the system 300 comprises a fuel tank assembly 332 that includes the fuel tank 312 that is appropriate for the fuel, a fuel pressure transducer 326, the smart controller 314, and a battery 340. In this embodiment, the fuel tank assembly 332 connects to the fuel cell 316 via tubing or the like for transporting the fuel from the fuel tank 312 to the fuel cell 316. Also, the fuel tank assembly 332 can be replaceable. Thus, a coupling mechanism can be provided for facilitating replacement of the fuel tank assembly 332. A coupling mechanism is not depicted in FIG. 3, however any appropriate mechanism for detachably coupling the fuel tank assembly 332 to the fuel cell pack 334 can be used. For example, the fuel tank assembly 332 can be simply inserted and withdrawn via a snap fit connector, or the fuel tank assembly 332 can be attached and detached from the fuel cell pack 334 via a threaded connector. The fuel tank assembly 332 also includes electrical connections to the fuel cell 316 and to the host processor 318 power control circuitry via control signal interface 336. In another embodiment, the fuel cell pack 334 is replaceable. In each of these embodiments, the components of the fuel cell pack 334 are enclosed in a housing similar to that used for current battery packs and that the fuel tank assembly 334 is refillable and easily replaceable by user. Thus, the fuel cell pack is interchangeable with and functionally compatible with a battery pack. For example, if the host processor 318 is a laptop computer capable of receiving electrical power from a battery pack, the fuel cell pack 334, is interchangeable with that battery pack and provides at least the same power and information to the laptop's operating system as the battery pack.

The fuel cell pack 334 also comprises a current sense circuit 320. The current sense circuit 320 senses the electrical current being provided to the host processor 318 from the fuel cell pack 334 and provides a signal indicative of this sensed electrical current to the smart controller 314. Also, a signal indicative of the voltage provided to the host processor 318 from the fuel cell pack 334 is provided to the smart controller 314 at voltage sense point 330. In another embodiment, the fuel cell pack 334 comprises a fuel reformer (not shown in FIG. 3) for converting the fuel contained in the fuel tank 312 to a fuel that is usable by the fuel cell 316. The fuel reformer can be integral to the fuel cell 316, separate from the fuel cell 316, or a combination thereof. As depicted in FIG. 3, the system 300 can also comprise a fan or other mechanical device for inducing airflow through the fuel cell 316. The fan can be integral to the fuel cell 316, separate from the fuel cell 316, or a combination thereof. The battery 340 can be internal to the fuel cell pack 334 or can be located in the host processor 318.

The smart controller 314 is electrically coupled to the fuel pressure transducer 326, the fuel valve 328, the fuel cell temperature sensor 324, the fuel tank temperature sensor 325, and the current sense circuit 320. The smart controller 314 also comprises the voltage sensor 330, which receives a signal indicative of the voltage of the power signal provided to the host processor 318. As described in more detail below, the smart controller 314 receives signals indicative of the sensed fuel cell temperature, the sensed fuel tank temperature, the sensed electrical current provided to the host processor 318, and fuel flowing through the fuel pressure transducer 326, and utilizes these parameters to control the amount of fuel provided to the fuel cell 318 via the fuel valve 328, and provides data pertaining to the fuel cell to the host processor 318.

The smart controller 314 provides information pertaining to the fuel cell pack 334 via the data signal interface 322. In an exemplary embodiment, the data signal interface 322 is a data bus interface compatible with the inter-IC (I²C) bus specification for communication with the host processor 318. The smart controller 314 also receives start and stop commands from the host processor 318 via the control signal interface 336. In the case where a fan or other mechanical mechanism is used to induce airflow through the fuel cell 316, the smart controller 314 will control this device as well.

In accordance with the present invention, the host processor 318 controls the operation of the fuel cell pack 334 via the control signal interface 336 and the smart controller 314 provides operational data about the fuel cell pack 334 to the host processor 318 via data interface 322. The fuel cell pack provides power to the host processor via power signal interface 338. The operating system of the host processor 318 utilizes the received operational data to control the fuel cell pack 334 and to provide an indication of the status of the fuel cell pack 334. Control can comprise, for example, starting up and shutting down the fuel cell pack 334, and metering the amount of fuel supplied to the fuel cell via fuel valve 328. Example operational data are the same as described above with respect to the system 200.

In one embodiment, parameters are pre-stored in the smart controller's 314 memory prior to using the fuel cell pack 334. The smart controller's 314 memory can include any appropriate storage mechanism such as permanently programmed registers, read only memory (ROM), locations in random access memory (RAM) (preferably non-volatile), disk storage, or a combination thereof, for example. Examples of pre-stored parameters are the same as provided in Table 1 above.

In operation, during a quiescent state, the fuel cell pack 334 is not generating power and is not consuming fuel. The smart controller 314 is in an idle state consuming minimal battery power from the battery 340 while awaiting a start signal from the host processor 318 via control signal interface 336. Once the host processor 318 asserts a start signal via the control signal interface 336, the smart controller 314 opens the fuel valve 328 and starts the fan (if utilized). The smart controller 314 also begins to monitor fuel tank pressure via the fuel pressure transducer 326, the fuel tank temperature via the temperature sensor 325, voltage output provided to the host processor 318 from the fuel cell pack 334 via power signal interface 338, the electrical current being drawn from the fuel cell pack 334 by the host processor 318 via the power signal interface 338, and the temperature of the fuel cell 324 via the temperature sensor 324.

In one embodiment, when the fuel cell pack 334 is providing its rated voltage to the host processor 318, the smart controller 314 uses power generated by the fuel cell 316 instead of from the battery 340. Additionally the electrical current supplied by the fuel cell 316 can be used to charge the battery in the host processor 318 and the fuel cell pack battery 340 (if separate from the host processor's 318 battery), rather than supplying power to the host processor 318 only.

The smart controller 314 continuously meters fuel from the fuel tank 312 to the fuel cell 316 by controlling the fuel valve 328 using an algorithm appropriate to the fuel cell 316 design. Additionally, the smart controller 314 continuously monitors the temperature of the fuel cell 316 via the temperature sensor 324, and if the temperature exceeds a pre-determined point the smart controller 314 can turn the fuel valve 328 off to prevent failure of, or damage to, the fuel cell 316 and/or the host processor 318.

The voltage output of the fuel cell 316 and the current drawn from the fuel cell 316 are continuously monitored by the smart controller 314 and made available for reporting to the host processor 318. The voltage and current sensor interfaces in the smart controller 314 can comprise any appropriate device, circuitry, and/or software, such as an integrated analog-to-digital converter, for example. Similarly, the temperature interface in the smart controller 314 can comprise any appropriate device, circuitry, and/or software, such as an integrated analog-to-digital converter, for example.

During operation the smart controller 314 calculates the volume of fuel remaining (F_{R}) (e.g., on a periodic basis) utilizing the output of the fuel pressure transducer 326 and the fuel tank temperature sensor 325. The smart controller 314 stores this value (F_{R}) in memory in the smart controller 314. Note that volumes of gaseous fuels are often expressed in moles. If the value of F_{R} is to be provided to a user, it can remain expressed in moles, be converted to other units, expressed as a percentage of the total amount of fuel, or a combination thereof. In one embodiment, the fuel remaining F_{R} is calculated in accordance with the following equation (4) derived from the ideal gas law (PV=nRT).

F_{R}=F_{P}V/RT, where (4)

F_{R} is the volume of the remaining fuel, in moles, in the fuel tank 312, T is the temperature Kelvin of the fuel tank 312, R is a universal gas constant for the type of gaseous fuel in the fuel tank 312, F_{P} is the pressure of the fuel in the fuel tank 312 and V is the volume of the fuel tank 312.

The smart controller 314 also calculates the remaining power capacity (C_{R}) that the fuel cell pack 334 can deliver. In one embodiment, the value of C_{R} is stored in a register or memory location in the smart controller 314. Note the value of C_{R} is not required to be stored in a non-volatile location. In one embodiment, the remaining power capacity, C_{R}, is calculated in accordance with the following equation (5).

C_{R}=n*K_{E}, (5)

where C_{R} is the value of the remaining power capacity, n is the number of moles of gaseous fuel in the fuel tank 312, and K_{E} is an energy conversion constant for the fuel cell 316.

The smart controller 314 also computes the average electrical current draw from the fuel cell 316 along with the predicted runtime of the system and the percentage of energy left in the fuel tank 312. In one embodiment, the predicted runtime is calculated in accordance with equation (3) described above.

These data are provided to the host processor 318 by the fuel cell pack 334. As provided to the host processor 318, these data are compatible with the standards and specifications with which the host processor 318 is compatible. In one embodiment, the smart controller 314 communicates with the host processor 318 via I²C bus (or other communication bus) when queried. Data transferred between the smart controller 314 and the host processor 318 are formatted to be in compliance with industry standard specifications such as the Smart Battery Specification and the Advanced Configuration and Power Interface (ACPI) Specification, for example. The data can also be formatted to be compatible with proprietary structures as specified by the host processor 318 manufacturer. Data provided to the host processor 318 can be used for the purpose of performing power management throughout the system (e.g., fuel cell pack 334 and the host processor 318) and/or to present the user with information about the fuel cell pack 334. Information pertaining to the fuel cell pack 334 can be presented to the user in the form of a visual display (e.g., fuel gauge, time remaining), in the form of an audio cue (e.g., time remaining is below a predetermined threshold value), a mechanical cue (e.g., hand held device vibrates when time remaining is below a predetermined threshold value), or a combination thereof, for example.

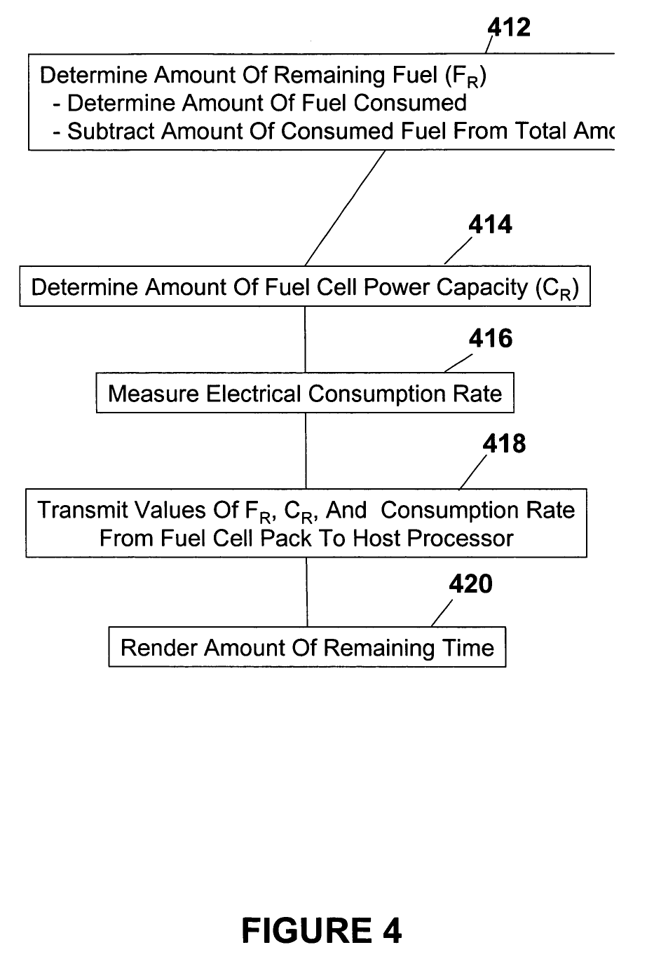

FIG. 4 is a flow diagram of an exemplary process for providing data from a fuel cell pack to a host processor in accordance with an embodiment of the present invention. The amount of remain fuel, F_{R}, is determined at step 412. The amount of fuel remaining can be determined by any appropriate orientation dependent and/or independent technique. In one embodiment, the value of F_{R} is determined, for example, as described above with respect to equations (1), (4), or a combination thereof. Other techniques for determining the amount of remaining fuel include weighing the fuel tank periodically and dividing by the weight per fluid volume, utilizing an electromechanical gauge (e.g., a gas gauge in an automobile), utilizing a sonic transducer to detect the surface of the liquid fuel, determining the free space in the fuel tank and calculating the liquid remaining, or a combination thereof, for example.

At step 414, the amount of Fuel Cell Power Capacity, C_{R}, is determined. The Fuel Cell Power Capacity, C_{R}, can be determined in any appropriate manner. In one embodiment C_{R} is determined in accordance with equations (2), (5), or a combination thereof. Another exemplary technique for determining C_{R} includes determining the total power capacity of the full fuel tank, measuring the amount of power produced at predetermined intervals using the current and voltage transducers, and at each measurement interval, subtracting the power produced during the interval from the previous total capacity. The electrical consumption rate is measured at step 416. The electrical consumption rate is measured as described above, for example. The electrical consumption rate is determinable via a current sense circuit (e.g., current sense circuits 220 and 320). The electrical consumption rate can be indicative of the amount of current being provided to the host processor (e.g., host processor 218 and 318), or to the amount of electrical current being provided to both the host processor and back to the fuel cell pack (e.g., recharging batter 240 and 320).

The data associated with the amount of remaining fuel, the amount of power capacity, and the consumption rate are provided to the host processor as described above. An indication of the amount of time remaining in which the fuel cell pack can provide power to the host processor (and optionally to recharge the fuel cell pack battery) is rendered by the host processor at step 420. In one embodiment of the present invention, the amount of time remaining is calculated by dividing the remaining capacity by the consumption rate, as described in equation (3).

The host processor's operating system can render the remaining time in various formats. For example, the remaining time can be visually displayed (e.g., similar to a fuel gauge in an automobile). Also, the remaining time can be indicated aurally as a chime, bell, or the like, when a predetermined amount of time is remaining. Further, the remaining amount of time can be rendered mechanically, via vibration or the like. An example of this latter case is applicable to a cell phone having its ring mode set to vibrate. When the remaining amount of time reaches a predetermined value, the cell phone vibrates, indicating that the cell phone's power source needs to be replenished.

A method for fuel cell control and data reporting as described herein may be embodied in the form of computer-implemented processes and system for practicing those processes. A method for fuel cell control and data reporting as described herein may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes a system for practicing the invention. The methods for fuel cell control and data reporting as described herein may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes a system for practicing the invention. When implemented on a general-purpose processor, the computer program code segments configure the processor to create specific logic circuits.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the signal processing services of the present invention, e.g., through the use of a data processing API or the like, are preferably implemented in a high level procedural or object oriented programming language to communicate with a computer. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While embodiments of the present invention has been described in connection with the illustrative embodiments of the various figures, it is to be understood that other similar embodiments may be used or modifications and additions may be made to the described embodiment for performing the same function of the present invention without deviating therefrom. Furthermore, it should be emphasized that a variety of computer platforms, including handheld device operating systems and other application specific operating systems are contemplated, especially as the number of wireless networked devices continues to proliferate. Therefore, the present invention should not be limited to any single embodiment, but rather should be construed in breadth and scope in accordance with the appended claims.

What is claimed:

1. A system for generating and providing fuel cell data to a processing system, said system comprising:
a fuel tank;
a fuel cell coupled to said fuel tank for receiving fuel within said fuel tank;
at least one sensor for sensing fuel cell characteristics and for providing sensor signals indicative of said fuel cell characteristic to a controller; and
said controller coupled to said fuel tank and to said fuel cell for determining fuel cell parameter values in accordance with said sensed fuel cell characteristics;
a processing system comprising a fuel indicator; and
a data bus for providing said fuel cell data from said fuel cell to said processing system, wherein:
said fuel cell data comprises at least one of said determined fuel cell parameters; and
said controller is coupled to said processing system via said data bus.

2. A system in accordance with claim 1, wherein said sensors comprise a temperature sensor for sensing a temperature of at least one of said fuel cell and said fuel tank.

3. A system in accordance with claim 1, wherein said sensors comprise a pressure sensor for sensing a pressure of said fuel tank.

4. A system in accordance with claim 1, wherein said sensors comprise a current sensor for sensing an electrical current provided by said fuel cell to said host processor.

5. A system in accordance with claim 1, wherein said sensors comprise a voltage sensor for sensing a voltage provided by said fuel cell to said host processor.

6. A system in accordance with claim 1, wherein said fuel is a gaseous fuel.

7. A system in accordance with claim 1, wherein said fuel is a liquid fuel.

8. A system in accordance with claim 1, wherein said fuel cell comprises at least one of a phosphoric acid fuel cell, a proton exchange membrane fuel cell, a molten carbonate fuel cell, a solid oxide fuel cell, an alkaline fuel cell, a direct method fuel cell, a regenerative fuel cell, a zinc-air fuel cell, and a protonic ceramic fuel cell.

9. A system in accordance with claim 1, wherein said data is formatted in accordance with at least one of an advanced configuration and power interface (ACPI) specification, an inter-IC (I²C) bus specification, a system management bus (SmBus) specification, and a smart battery charger specification.

10. A system in accordance with claim 1, wherein said processing system is a laptop computer.

11. A system in accordance with claim 10, wherein:
said laptop computer is operational with a battery pack; and
said fuel cell is functionally compatible and physically interchangeable with said battery pack.

12. A system in accordance with claim 1, further comprising:
a flow meter coupled between said fuel tank and said fuel cell for measuring fuel consumption and providing a fuel consumption signal indicative of said consumed amount of fuel to said controller.

13. A system in accordance with claim 12, wherein:
said controller:
determines a remaining amount of fuel in said fuel cell in accordance with said consumed amount of fuel;
determines a remaining amount of fuel cell power in accordance with said remaining amount of fuel;
determines an electrical consumption rate being consumed by said computer operating system in accordance with a sensed electrical current provided by said fuel cell to said processing system; and
transmits values indicative of said remaining amount of power and said electrical consumption rate from said fuel cell to a computer operating system residing in the processing system via said data bus.

14. A system in accordance with claim 11, wherein:
said operating system determines an amount of remaining time for said fuel cell to provide power to an associated computer operating system in accordance with said transmitted values indicative of said remaining amount of power and said electrical consumption rate.

15. A system in accordance with claim 14, wherein said operating system renders said amount of remaining time via said processing system.

16. A system in accordance with claim 1, wherein:
said fuel is a gaseous fuel; and
said smart controller determines a remaining amount of fuel in accordance with a sensed temperature of said fuel tank, a sensed pressure within said fuel tank; and a volume of said fuel tank.

17. A method for providing data from a fuel cell pack to a computer operating system, said method comprising:
determining a remaining amount of fuel in said fuel cell pack;
determining a remaining amount of fuel cell power in accordance with said remaining amount of fuel;
determining an electrical consumption rate being consumed by said computer operating system; and
transmitting values indicative of said remaining amount of power and said electrical consumption rate from said fuel cell pack to said computer operating system.

18. A method in accordance with claim 17, said act of determining a remaining amount of fuel comprising:
measuring fuel consumption within said fuel cell pack;
determining an aggregate amount of consumed fuel in accordance with said measured fuel consumption; and
subtracting said aggregate amount of consumed fuel from a total amount of fuel, wherein said total amount of fuel is an amount of fuel in said fuel tank when said fuel tank is filled to capacity.

19. A method in accordance with claim 17, wherein:
said fuel is a gaseous fuel; and
said act of determining a remaining amount of fuel comprises:
measuring a temperature of a fuel tank of said fuel cell pack;
measuring a pressure within said fuel tank; and
determining said remaining amount of fuel in accordance with said measured temperature, said measured pressure, and a volume of said fuel tank.

20. A method in accordance with claim 17, further comprising:
determining an amount of remaining time for said fuel cell pack to provide power to said computer operating system in accordance with said transmitted values indicative of said remaining amount of power and said electrical consumption rate.

21. A method in accordance with claim 20, further comprising:
rendering said amount of remaining time.

22. A method in accordance with claim 20, wherein said amount of remaining time is at least one of audibly rendered, mechanically rendered, and visually rendered.

23. A computer-readable medium encoded with computer program code for directing a computer processor to provide data from a fuel cell pack to a computer operator system, said program code comprising:
a determine remaining fuel code segment for causing said computer processor to determine a remaining amount of fuel in said fuel cell pack;
a determine remaining fuel cell power code segment for causing said computer processor to determine a remaining amount of fuel cell power in accordance with said remaining amount of fuel;
a measure current code segment for causing said computer processor to measure an electrical consumption rate being consumed by said computer operating system; and
a transmit code segment for causing said computer processor to transmit values indicative of said remaining amount of power and said electrical consumption rate from said fuel cell pack to said computer operating system.

24. A computer-readable medium in accordance with claim 23, wherein said determine remaining fuel code segment comprises:
a measure fuel consumption code segment for causing said computer processor to measure fuel consumption within said fuel cell pack;
a determine aggregate code segment for causing said computer processor to determine an aggregate amount of consumed fuel in accordance with said measured fuel consumption; and
a subtract code segment for causing said computer processor to subtract said aggregate amount of consumed fuel from a total amount of fuel, wherein said total amount of fuel is an amount of fuel in said fuel tank when said fuel tank is filled to capacity.

25. A computer-readable medium in accordance with claim 23, wherein:
said fuel is a gaseous fuel; and
said determine remaining fuel code segment comprises:
a measure temperature code segment for causing said computer processor to measure a temperature of a fuel tank of said fuel cell pack; and
a measure pressure code segment for causing said computer processor to measure a pressure within said fuel tank, wherein:
said remaining amount of fuel is determined in accordance with said measured temperature, said measured pressure, and a volume of said fuel tank.

26. A computer-readable medium in accordance with claim 23, said program code further comprising:
a determine remaining time code segment for causing said computer processor to determine an amount of remaining time for said fuel cell pack to provide power to said computer operating system in accordance with said transmitted values indicative of said remaining amount of power and said electrical consumption rate.

27. A computer-readable medium in accordance with claim 26, further comprising:
a render code segment for causing said computer processor to render said amount of remaining time.

28. A computer-readable medium in accordance with claim 26, wherein said amount of remaining time is at least one of audibly rendered, mechanically rendered, and visually rendered.
